(19) United States
(12) Patent Application Publication
(10) Pub. No.: US 2016/0178785 A1
(43) Pub. Date: Jun. 23, 2016

(54) Methods and Systems for Monitoring Spontaneous Potentials in Downhole Environments

(71) Applicant: HALLIBURTON ENERGY SERVICES INC., Houston, TX (US)

(72) Inventors: Glenn A. WILSON, Houston, TX (US); Burkay DONDERICI, Houston, TX (US)

(73) Assignee: Halliburton Energy Services, Inc., Houston, TX (US)

(21) Appl. No.: 14/911,228

(22) PCT Filed: Dec. 20, 2013
(86) PCT No.: PCT/US2013/076792

§ 371 Date: Feb. 9, 2016

(51) Int. Cl. G01V 3/26; E21B 47/00; E21B 49/08

(52) U.S. Cl. CPC G01V 3/265; E21B 49/08; E21B 47/00

(57) ABSTRACT

A spontaneous (SP) monitoring system includes a plurality of EM field sensors positioned in a downhole environment. The SP monitoring system also includes a processing unit in communication with the plurality of EM field sensors. The processing unit determines SP data for the downhole environment using a multi-frequency SP model and EM field measurements collected by the plurality of EM field sensors. The processing unit performs an inversion process based at least in part on the SP data to obtain a model of subsurface fluid.

### BACKGROUND

During oil and gas exploration and production, many types of information are collected and analyzed. The information is used to determine the quantity and quality of hydrocarbons in a reservoir, and to develop or modify strategies for hydrocarbon production. One technique for collecting relevant information involves monitoring spontaneous potentials (SPs) due to electrokinetic, thermoelectric, and/or electrochemical fluid transport processes within a reservoir. Previous SP monitoring techniques modeled SPs as purely direct current (DC) phenomena, and do not appear to have adequately addressed the obstacles to integrate electronics with downhole tools or wells to perform SP monitoring. Such obstacles include high temperatures, vibrations, space limitations, etc. Efforts to improve SP monitoring techniques for downhole environments are ongoing.

### BRIEF DESCRIPTION OF THE DRAWINGS

Accordingly, there are disclosed herein various spontaneous potential (SP) monitoring methods and systems that use a multi-frequency SP model. In the drawings:

FIG. 1 shows an illustrative well with a casing mounted sensor array.

FIG. 2 shows another illustrative well with a tubing mounted sensor array.

FIG. 3 shows yet another illustrative well with a wireline sensor array.

FIGS. 4A and 4B show illustrative electromagnetic (EM) field sensor telemetry configurations.

FIG. 5 shows a data flow chart of an illustrative reservoir monitoring process.

FIG. 6A-6C show log profiles for an illustrative formation model.

FIG. 7 shows an illustrative SP-based reservoir monitoring method.

It should be understood, however, that the specific embodiments given in the drawings and detailed description below do not limit the disclosure. On the contrary, they provide the foundation for one of ordinary skill to discern the alternative forms, equivalents, and other modifications that are encompassed in the scope of the appended claims.

### DETAILED DESCRIPTION

The following disclosure presents a spontaneous potential (SP) monitoring technology suitable for use in downhole environments. The disclosed techniques employ a plurality of downhole electromagnetic (EM) field sensors to measure ambient EM fields. These ambient EM fields include SPs due to electrokinetic, thermoelectric, and/or electrochemical fluid transport processes within a reservoir. SP data for the downhole environment is determined using a multi-frequency SP model and the EM field measurements collected by the plurality of EM field sensors. The SP data can be inverted to determine properties and/or to provide a model of fluids in the downhole environment.

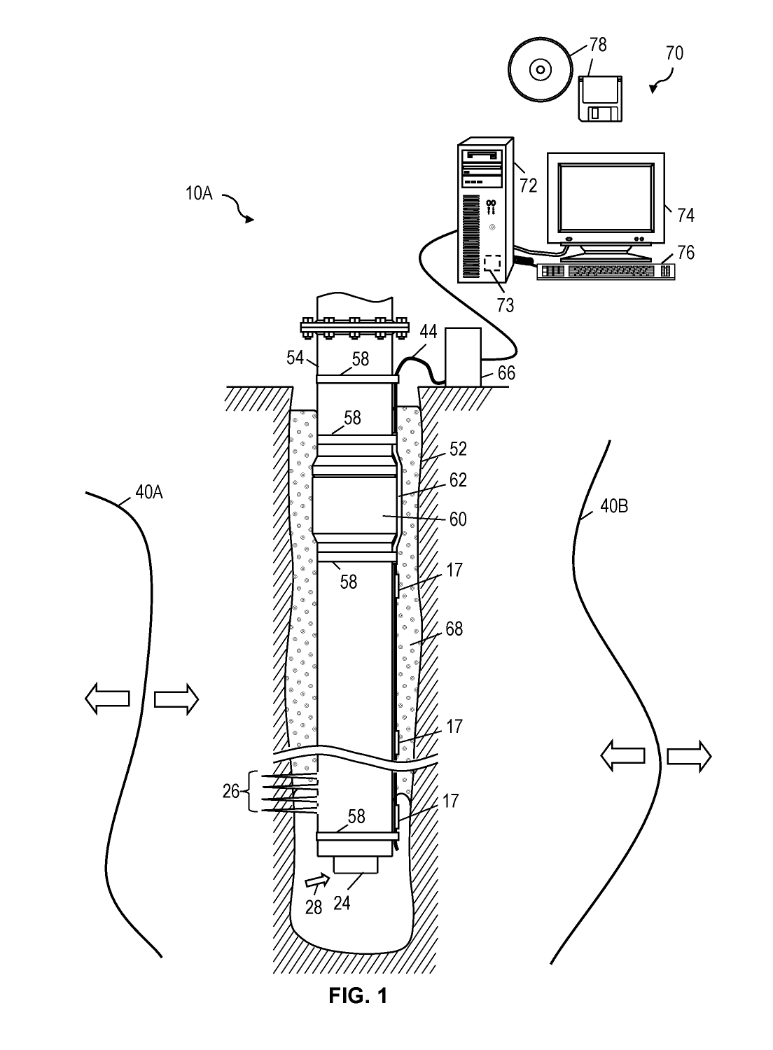

The disclosed SP monitoring system and method embodiments can be best appreciated in suitable application contexts such as a monitoring well, production well, or injection well environment. FIG. 1 shows an illustrative well 10A with a borehole 52 containing a casing string 54 with a cable 44 secured to it by bands 58. The casing string 54 includes multiple tubular casing sections (usually about 30 foot long) connected end-to-end by couplings. The cable 44 enables data and/or power transmissions and may correspond to an electrical conductor or optical fibers. Where the cable 44 passes over a casing joint 60, it may be protected from damage by a cable protector 62. The remaining annular space in the borehole 52 may be filled with cement 68 to secure the casing string 54 in place and to prevent fluid flows in the annular space.

The well 10A is adapted to guide fluids 28 (e.g., oil or gas) from the bottom of the borehole 52 to earth's surface. For example, fluids can enter the borehole 52 through uncemented portions or via perforations 26. Such perforations 26 near the bottom of the borehole 52 may extend through cement 68 and casing string 54 to facilitate the flow of fluid 28 from a surrounding formation (i.e., a “formation fluid”) into the borehole 54 and thence to the surface via an opening at the bottom of or along production tubing string 24. Though only one perforated zone is shown for well 10A, many wells may have multiple such zones, which enable production from different formations. Each such formation may produce oil, gas, water, or combinations thereof at different times. Alternatively, the well 10A may inject fluid into the borehole 52 and the different formations.

As an example, the fluid 28 produced by the well 10A may include oil or gas along with water originating from one or more sources. Any water in the fluid 28 may be a mixture of water from the surrounding formation (i.e., “formation water” such as connate water) and fracturing fluid previously pumped into the surrounding formation under high pressure via the production tubing string 24. Alternately, or in addition, the produced water may include water from other formations, or injected water from injection wells (e.g., flood fluid from a remote well). It is noted that the configuration of well 10A in FIG. 1 is illustrative and not limiting on the scope of the disclosure.

In FIG. 1, EM field sensors 17 couple to the cable 44 to enable collection of EM field measurements that are conveyed to a surface interface 66 via the cable 44. The surface interface 66 may be coupled to a computer 70 that acts as a data acquisition system and/or a data processing system that analyzes the EM field measurements to derive subsurface parameters and track them over time. As an example, the computer 70 may process the EM field measurements to determine SPs due to electrokinetic, thermoelectric, and/or electrochemical fluid transport processes within a reservoir. As described herein, telluric cancellation and a multi-frequency SP model may be used to obtain SP data for the downhole environment. In some contemplated system embodiments, the computer 70 may further control production parameters to optimize production based on the information derived from the SP data or other downhole measurements.

The computer 70 includes a chassis 72 that houses various electrical components such as processor 73, memories, drives, graphics cards, etc. The computer 70 also includes a monitor 74 that enables a user to interact with the software via a keyboard 76 or other input devices. Examples of input devices that may be used with or instead of keyboard 76 include a mouse, pointer devices, and touchscreens. Further, other examples of output devices that may be used with or instead of monitor 74 include a printer. Software executed by the computer 70 can reside in computer memory and on non-transitory information storage media 78. The computer may be implemented in different forms including, for example, an embedded computer installed as part of the surface interface 66, a portable computer that is plugged into the surface interface 66 as desired to collect data, a remote desktop computer coupled to the surface interface 66 via a wireless link and/or a wired computer network, a mobile phone/PDA, or indeed any electronic device having a programmable processor and an interface for I/O.

In accordance with at least some embodiments, the processor 73 receives ambient EM field measurements from the plurality of the EM field sensors 17. The processor 73 determines SP data for the downhole environment using a multi-frequency SP model and the received ambient EM field measurements. The processor 73 may perform an inversion process based at least in part on the SP data to obtain a model of or to otherwise monitor subsurface fluids such as fluid fronts 40A or 40B as they move towards or away from the well 10A.

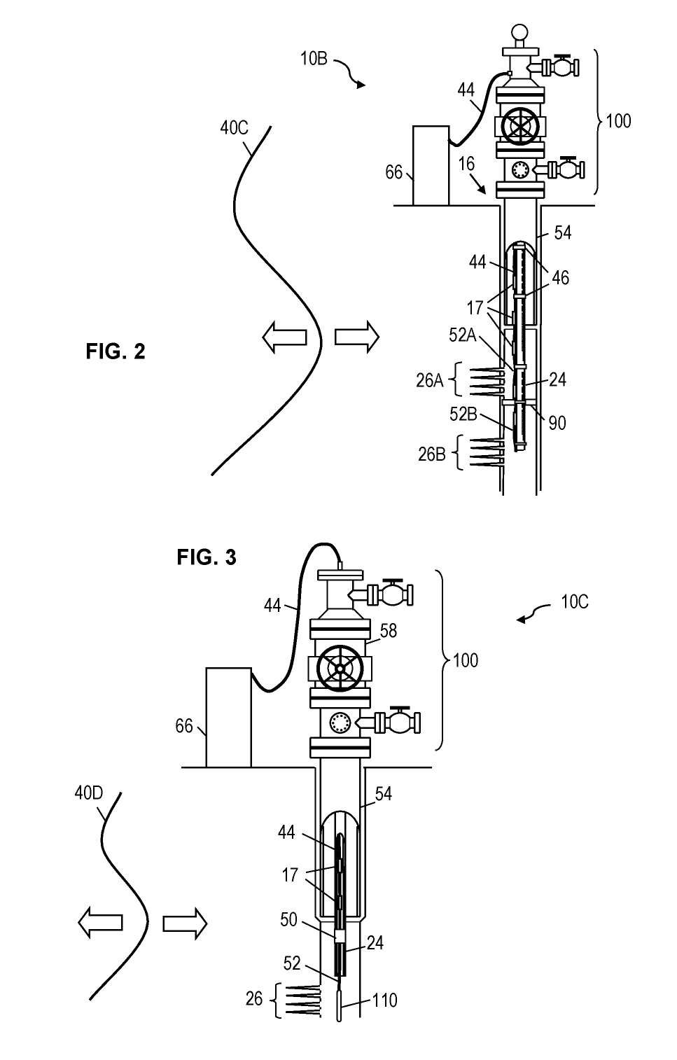

FIG. 2 shows another well 10B where the cable 44 is strapped to the outside of the production tubing string 24 rather than the outside of casing string 54. Two perforations 26A and 26B have been created in the borehole 16 to facilitate the obtaining of formation fluids from two different zones. Formation fluid from a first of the two zones enters the casing string 54 via the perforation 26A, and formation fluid from the other zone enters the production tubing string 24 via the perforation 26B. A packer 90 seals an annulus around the production tubing string 24 to define the two different zones.

In the embodiment of FIG. 2, the EM field sensors 17 are positioned along cable 44 and are in communication with a surface interface 66 via the cable 44. While the casing string 54 may cause some attenuation of EM fields, the disclosed SP monitoring technique is still viable, especially at low frequencies where attenuation due to the casing string 54 is low. To reduce the amount of attenuation, a composite material may used for the casing string 54.

As shown, the cable 44 may exit through an appropriate port in a “Christmas tree” 100, which includes an assembly of valves, spools, and fittings connected to a top of a well to direct and control a flow of fluids to and from the well 10B. The cable 44 extends along the outer surface of the production tubing string 24, and is held against the outer surface of the of the production tubing string 24 at spaced apart locations by multiple bands 46 that extend around the production tubing string 24. In other embodiments, multiple EM field sensors 17 may be coupled to one or more surface interfaces 66 via different fiber optic cables extending along the outer surface of the production tubing string 24.

FIG. 3 shows another well 10C having the cable 44 and the EM field sensors 17 suspended inside production tubing string 24. A weight 110 or other conveyance mechanism is employed to deploy and possibly anchor the cable 44 within the production tubing string 24 to minimize risks of tangling and movement of the cable from its desired location. The EM field sensors 17 may be distributed along the cable 44, which exits the well 10C via an appropriate port in Christmas tree 100 and attaches to the surface interface 66. While the production tubing string 24 and/or casing string 54 may cause some attenuation of EM fields, the disclosed SP monitoring technique is still viable, especially at low frequencies where attenuation due to the production tubing string 24 and/or casing string 54 is low. To reduce the amount of attenuation, a composite material may used for the production tubing string 24 and/or casing string 54.

The measurements collected by the EM field sensors 17 in wells 10B and 10C may be processed by a computer, such as computer 70 in FIG. 1, to determine SP data for the respective downhole environments using a multi-frequency SP model. An inversion process based at least in part on the SP data is used to obtain a model of or to otherwise monitor subsurface fluids such as fluid fronts 40C (in FIG. 2) or 40D (in FIG. 3) as they move towards or away from the respective wells 10B and 10C.

In alternative embodiments, cable 44 may correspond to wired casing or wired production tubing with couplers that provide continuity of integrated electrical or optical paths. In such embodiments, some or all of the couplers may further include integrated EM field sensors 17. Alternatively, cable 44 could be arranged inside or outside of normal, metallic coiled tubing. Further, in at least some embodiments, the EM field sensors 17 use wireless communications to convey EM field measurements to the surface or to a downhole interface that conveys the measurement received from the EM field sensors 17 to the surface. The EM field sensors 17 may in some cases implement a mesh network to transfer data in a bucket-brigade fashion to the surface.

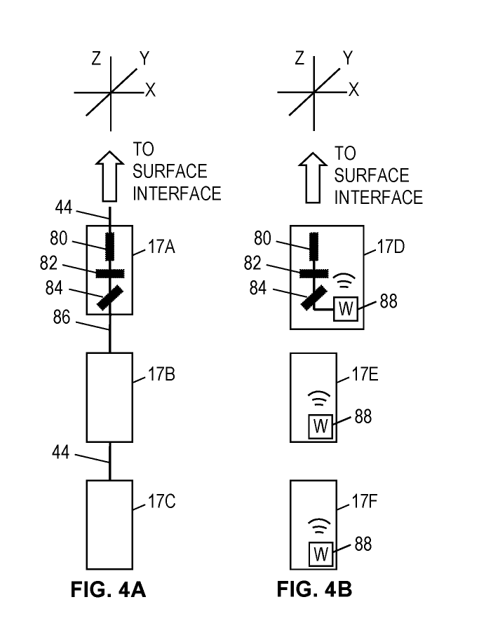

FIGS. 4A and 4B show illustrative EM field sensor telemetry configurations that could be implemented in the well environments of FIGS. 1-3. In FIG. 4A, sensor groups 17A-17C couple to cable 44 to perform ambient EM field measurements and/or to convey ambient EM field measurements to a surface interface (e.g., interface 66). Each of the sensor groups 17A-17C includes orthogonal EM field sensors 80, 82, 84 (not shown for groups 17B and 17C), where sensor 80 is oriented along the z-axis, sensor 82 is oriented along the x-axis, and sensor 84 is oriented along the y-axis. In some embodiments, the cable 44 corresponds to one or more electrical conductors to carry data and/or power. In such case, the EM field sensors 80, 82, 84 may correspond to coils or another type of transducer that generates or modifies an electrical signal in response to an ambient EM field. The generated or modified electrical signal is transmitted to a surface interface (e.g., interface 66) via cable 44, where its characteristics can be interpreted to decode information about the EM field sensed by one or more of the sensors 80, 82, 84 in sensor groups 17A-17C.

In another embodiment, the cable 44 corresponds to one or more optical fibers to carry data and/or power. In such case, the EM field sensors 80, 82, 84 generate or modify a light signal in response to sensing an ambient EM field. The generated or modified light signal is transmitted to a surface interface (e.g., interface 66) via one or more optical fibers. The surface interface converts the light signal to an electrical signal, whose characteristics encode information about the EM field sensed by sensor groups 17A-17C. It should also be understood that electro-optical converters may also be employed to change electrical signals to optical signals or vice versa. Thus, EM sensor technology that generates or modifies a light signal could be part of a system where cable 44 has electrical conductors. In such case, the generated or modified light signal is converted to an electrical signal for transmission via cable 44. Similarly, EM sensor technology that generates or modifies an electrical signal could be part of a system where cable 44 has optical fibers. In such case, the generated or modified electrical signal is converted to a light signal for transmission via cable 44.

In FIG. 4B, each of the sensor groups 17D-17F includes orthogonal EM field sensors 80, 82, 84 (not shown for groups 17E and 17F), oriented as described for FIG. 4A. Further, each of the sensor groups 17D-17F includes a wireless interface 88 to enable communications with a surface interface (e.g., interface 66). Each wireless interface 88 may include a battery, at least one wireless module, and a controller. In at least some embodiments, the wireless interfaces 88 are part of a wireless mesh in which short-range wireless communications are used to pass data from one wireless interface 88 to another until the data is received by a surface interface. As an example, a short-range wireless protocol that could be employed by each wireless interface 88 is Bluetooth®. EM field sensor configurations such as those shown in FIGS. 4A and 4B may vary with respect to the position of sensor groups, the types of sensors used, the orientation of sensors, the number of cables/fibers used, the wireless protocols used, and/or other features.

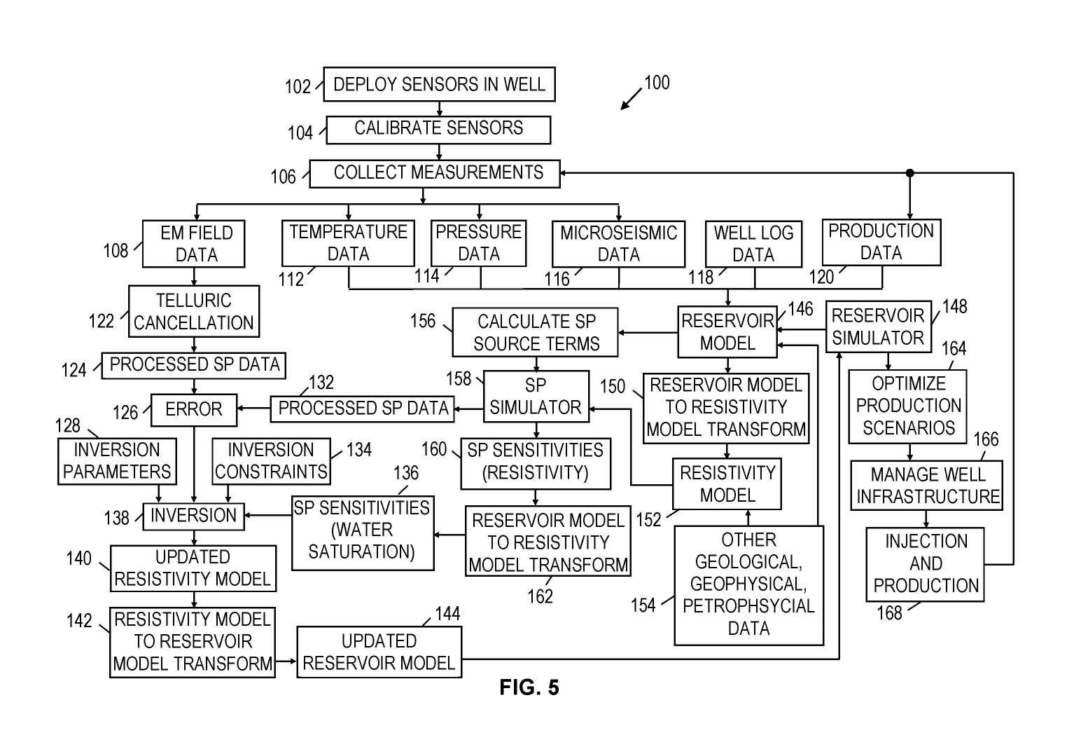

FIG. 5 shows a data flow chart 100 of an illustrative reservoir monitoring process. Some of the steps in chart 100 may be performed, for example, by software modules or processes executing on one or more processors or computers in communication with EM field sensors deployed in a well environment as described herein. In accordance with at least some embodiments, the SP monitoring steps in chart 100 are performed without an EM field source. At block 102, various sensors are deployed in a well. At block 104, the sensors are calibrated. Thereafter, measurements are collected at block 106 using the calibrated sensors. Example measurements collected at block 106 include EM field data 108, temperature data 112, pressure data 114, and microseismic data 116.

The EM field data 108 is processed to cancel telluric data at block 122 to obtain SP data 124. The SP data 124 is compared with SP data 132 resulting from SP simulation operations at block 158. The comparison results in an error value 126, which is provided as input to inversion block 138. The inversion block 138 also receives as input inversion parameters 128, inversion constraints 134, and SP sensitivities (e.g., water saturation) 136. The results of the inversion operations of block 138 are used to obtain an updated resistivity model 140. Transform operations at block 142 are used to obtain an updated reservoir model 144 from the resistivity model 140.

Meanwhile, the temperature data 112, the pressure data 114, and the microseismic data 116 are input to a reservoir model 146. Well log data 118 and production data 120 may also be input to the reservoir model 146. The reservoir model 146 is used to calculate SP source terms at block 156. Further, transform operations are performed to obtain a resistivity model 152 from the reservoir model 146 at block 150. The resistivity model 152 is also based on other geological, geophysical, petrophysical data 154. As shown, the resistivity model 152 and the SP source terms obtained at block 156 are input to SP simulator 156, which determined the simulation-based SP data 132 discussed previously. The SP simulator 158 also determines SP sensitivities (e.g., resistivity) 160 that are input to block 162 for transform operations to obtain a resistivity model from the reservoir model 146. The SP sensitivities (water saturation) 136 input to inversion block 138 as discussed previously are obtained from the transform operations of block 162.

The reservoir model 146 receives other inputs besides data 112, 114, 116, 118, and 120. More specifically, other geological, geophysical, or petrophysical data 154 may be provided as input to the reservoir model 146. In addition, parameters or outputs determined by a reservoir simulator 148 may be provided as input to the reservoir model 146. Outputs of the reservoir simulator 148 also may be used to optimize production scenarios at block 164. The optimized scenarios are used to manage well infrastructure at block 166. With the managed infrastructure determined at block 166, production and injection operations are preformed at block 168. The production data 120 discussed previously may be obtained from the operations of block 168. The process of monitoring a downhole environment, obtaining inverted data, updating models, comparing measurement results with simulation results, managing well infrastructure, and performing injection/production as described in chart 100 can be repeated as needed.

To summarize, the transient electric and/or magnetic fields of SPs due to electrokinetic, thermoelectric, and/or electrochemical fluid transport processes within a reservoir are measured using distributed EM field sensors temporarily or permanently deployed within at least one well. Additional measurements of pressure, temperature, salinity, and other physical quantities (e.g., microseismic events) may be made from the same distributed sensor system. The transient electric and/or magnetic fields of the SP are processed and transformed to the frequency domain as processed SP data. Remote reference electric and/or magnetic fields may be measured for the purpose of telluric cancellation to improve signal-to-noise of the processed SP data.

In at least some embodiments, a reservoir model is constructed from available geological, geophysical, petrophysical, and production data. Further, an effective medium model described by an analytic formula is used to transform rock and fluid attributes of the reservoir model to a resistivity attribute of the reservoir model. The pressure, temperature, and salinity gradients are extracted from the reservoir model, and with appropriate coupling coefficients, construct the SP source terms. The resistivity model and SP source terms are used to predict SP data and to compute the SP sensitivities with respect to resistivity. The medium model is also used to transform the SP sensitivities with respect to resistivity to the SP sensitivities with respect to the water saturation.

In one embodiment, an iterative inversion is performed to generate an updated water saturation model that minimizes the misfit between the processed and predicted SP data subject to regularization and other imposed constraints such as mass conservation. In another embodiment of the invention, the SP data are jointly inverted with other geophysical data measured by the sensor system, such as pressure, temperature, electrical, electromagnetic, gravity, and/or seismic data. Upon termination of the iterative inversion, the updated water saturation model is input to the reservoir simulator for optimizing injection and/or production scenarios. The optimal injection and/or production scenario is selected with appropriate modification to well infrastructure such as multi-zone intelligent completions during injection and/or production. The whole process is operates continuously and can operate without intervention.

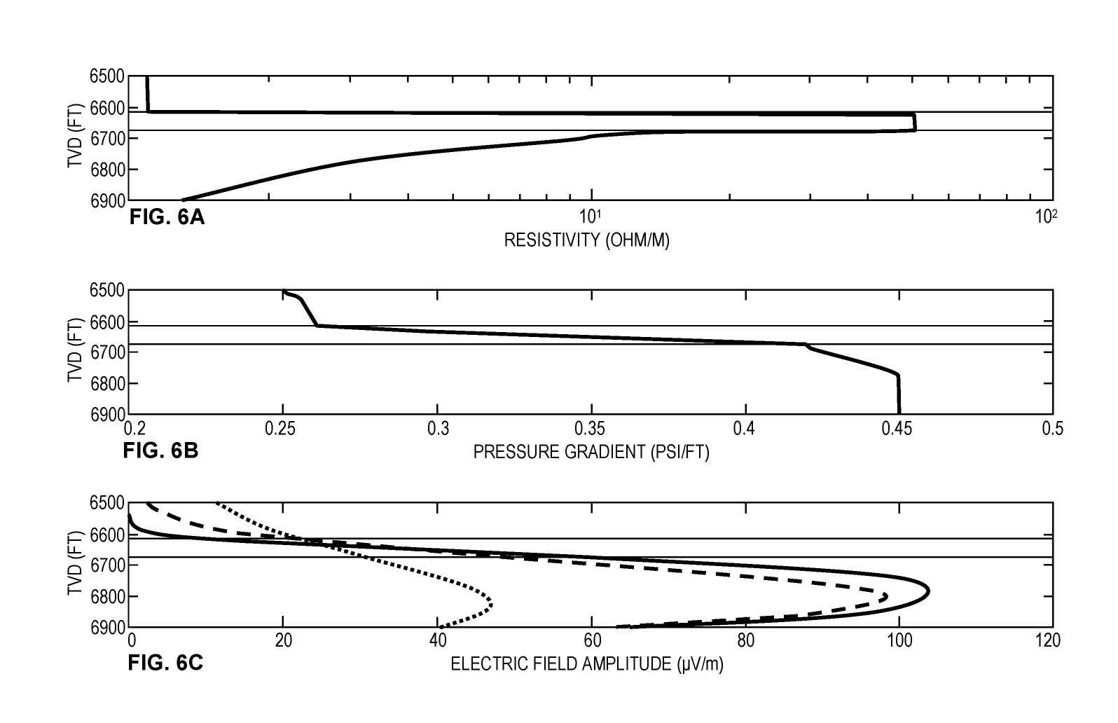

A model study corresponding to FIGS. 6A-6C demonstrates the feasibility of the disclosed approach. The model itself is based on a reservoir scenario published in T. S. Al-Mousa, S. K. Mohammed, A. A. Dashash, and A. J. Al-Mubairik, Using pressure gradient survey as a cost-effective diagnostic and decision-making tool: SPE Saudi Arabia Technical Symposium, Dhahran, SPE 110975 (2007). In the model study, a vertical well producing from a reservoir with bottom water drive is considered. In the proximity of the well, the formation can be represented with a one-dimensional (1D) earth model. The top of reservoir (TOR) is at 6615 feet depth. The oil-water contact is at 6675 feet depth. The pressure gradient within the reservoir is independently known from pressure gradient measurements. A typical value for the electrokinetic coupling parameter was used to relate the pressure gradients as an SP source. See M. D. Jackson, M. Y. Gulamali, E. Leinov, J. H. Saunders, and J. Vinogradov, Spontaneous potentials in hydrocarbon reservoirs during waterflooding: Application to water-front monitoring: SPE Journal, 17 (1), 53-69 (2012). The vertical electric field due to SP sources is measured along the well casing.

In FIG. 6A, a resistivity profile for the reservoir in the model study is shown. In FIG. 6B, a pressure gradient profile for the reservoir in the model study is shown. In FIG. 6C, a profile of the amplitude of the vertical electric field simulated along the well casing of the model study for different frequencies is shown. More specifically, the dotted line corresponds to a frequency of 100 Hz, the dashed line corresponds to a frequency of 1,000 Hz, and the solid line corresponds to a frequency of 10,000 Hz.

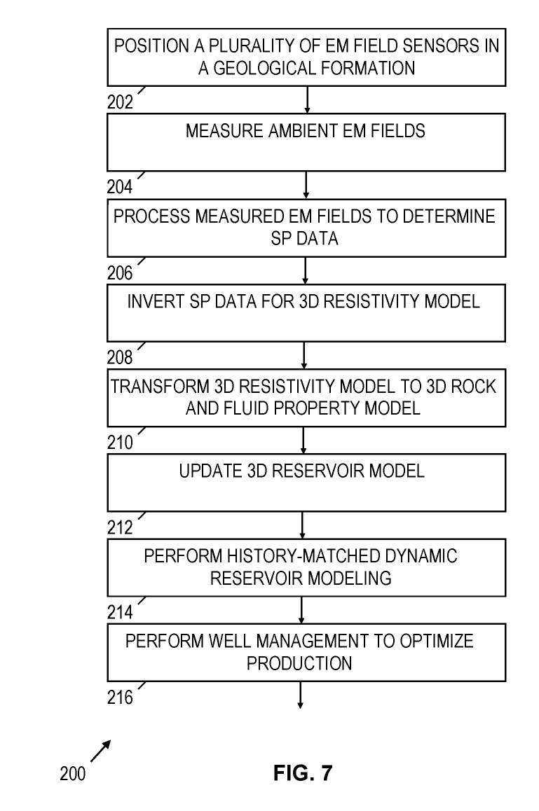

FIG. 7 shows a flowchart of an illustrative SP monitoring method 200. The method 200 may be performed in part by a processor or computer in communication with EM field sensors distributed in a well environment as described herein. At block 202, a plurality of EM field sensors are positioned in a geological formation, e.g., as part of a production well, injection well, or monitoring well, or any combination thereof in any number of boreholes. At block 204, ambient EM fields are measured at each of the sensor positions and, where available, in each component of the multi-component sensors. At block 206, measured EM fields are processed to determine SP data. At block 208, SP data is inverted to obtain a 3D resistivity model. The 3D resistivity model is transformed to a 3D rock and fluid property model at block 210. Further, at block 212, a 3D reservoir model may be updated using the 3D rock and fluid property model obtained at block 210. History-matched dynamic reservoir modeling is performed at block 214 using the updated 3D reservoir model obtained at block 212. Finally, well management to optimize production is performed at block 216 based at least in part on information obtained through the history-matching operations of block 214.

An explanation of the processing and inversion steps (block 206 and 208) in method 200 will now be given. Injection and/or production operations for reservoirs involve the simultaneity of multiple, irreversible transport processes that establish a thermodynamic system that is not in an equilibrium state. The different transport processes interfere with each other. The generalized constitutive relation describing these coupled processes was originally established by Osnager:

Jᵢ=Σⱼ LᵢⱼXⱼ, (1)

where the fluxes Jᵢ are related to primary and coupled forces Xⱼ through the coupling coefficients Lᵢⱼ, where Lᵢⱼ=Lⱼᵢ due to reciprocity. See e.g., L. Onsager, Reciprocal relation in irreversible processes: Physical Review, 37, 405-426 (1931). Such coupled systems describe the SPs attributed to the electromagnetic phenomena of electrokinetics, thermoelectrics, electroosmosis, and electrolyte diffusion that occur from fluid transport in the reservoir during injection and production. See e.g., D.J. Marshall, and T.R. Madden, Induced polarization, a study of its causes: Geophysics, 24 (4), 790-816 (1959); and B. Nourbehecht, Irreversible thermodynamic effects in inhomogeneous media and their applications in certain geoelectric problems: Ph. D. thesis, Massachusetts Institute of Technology (1963).

For example, the constitutive relations of Ohm's Law, Darcy's Law, Fourier's Law, and Fick's Law are respectively coupled as:

$$[ \begin{matrix}{J}_{1} \\ {J}_{2} \\ {J}_{3} \\ {J}_{4}\end{matrix} ] = [ \begin{matrix}{L}_{11} & {L}_{12} & {L}_{13} & {L}_{14} \\ {L}_{12} & {L}_{22} & {L}_{23} & {L}_{24} \\ {L}_{13} & {L}_{23} & {L}_{33} & {L}_{34} \\ {L}_{14} & {L}_{24} & {L}_{34} & {L}_{44}\end{matrix} ] [ \begin{matrix}E \\ ∇ P \\ ∇ T \\ ∇ C\end{matrix} ] . \qquad ( 2 )$$

For example, the pressure gradient of the oil-water contact in a reservoir undergoing waterflood will generate SPs. Similarly, the temperature gradient within a reservoir undergoing waterflood will generate SPs. Also, the salinity gradient within the brine of a reservoir undergoing waterflood will generate SPs. These SP sources are superimposed in the total SP signal. In particular, each of different SP sources can be related to the water saturation. For this reason, SPs can be related to reservoir fluid movement without need to decoupling the different sources.

It is valid to assume that the SPs only arise due to charge separation related to the different primary flows and their effects on the primary flows are negligible. See e.g., W. R. Sill, Self-potential modeling of primary flows: Geophysics, 48 (1), 76-86 (1983). It follows that Ohm's Law decouples from the other primary flows:

$$[ \begin{matrix}{J}_{1} \\ {J}_{2} \\ {J}_{3} \\ {J}_{4}\end{matrix} ] = [ \begin{matrix}{L}_{11} & {L}_{12} & {L}_{13} & {L}_{14} \\ 0 & {L}_{22} & {L}_{23} & {L}_{24} \\ 0 & {L}_{23} & {L}_{33} & {L}_{34} \\ 0 & {L}_{24} & {L}_{34} & {L}_{44}\end{matrix} ] [ \begin{matrix}E \\ ∇ P \\ ∇ T \\ ∇ C\end{matrix} ] . \qquad ( 3 )$$

The modified Ohm's Law:

J₁=σE+L₁₁∇P+L₁₂∇T+L₁₃∇C, (4)

implies that the coupled primary flows for pressure, temperature, and salinity transport can be solved independently of Ohm's Law, for example, with a fully-coupled mulitphase flow simulator (e.g., Halliburton's NEXUS® software). See e.g., B. K. Coats, G. C. Fleming, J. W. Watts, M. Rame, and G. S. Shiralkar, A generalized wellbore and surface facility model, fully coupled to a reservoir simulator: SPE Reservoir Simulation Symposium, Houston, SPE 79704 (2003). These primary flows, and their respective coupling coefficients, establish the distributed source terms for the subsequent modeling of the electric and magnetic fields.

Prior work on SP modeling and inversion has assumed that the SPs are DC electric fields and satisfy the coupled continuity condition:

∇·[σE]=−∇·[L₁₁∇P+L₁₂∇T+L₁₃∇C]. (5)

See e.g., W. R. Sill, Self-potential modeling of primary flows: Geophysics, 48 (1), 76-86 (1983); B. Wurmstich, and F. D. Morgan, Modeling of streaming potential responses caused by oil well pumping: Geophysics, 59 (1), 46-56 (1994); B. J. Minsley, J. Sogade, and F. D. Morgan, Three-dimensional self-potential inversion for subsurface DNALP contaminant detection at the Savannah River Site, South Carolina: Water Resources Research, 43, W04429, doi: 10.1029/2005WR003996 (2007); M. R. Sheffer, and D. W. Oldenburg, Three-dimensional modeling of streaming potential; Geophysical Journal International, 169, 839-848 (2007); A. Jardani, A. Revil, A. Boleve, and J. P. Dupont, Three-dimensional inversion of self-potential data used to constrain the pattern of groundwater flow in geothermal fields: Journal of Geophysical Research, 113, B09204, doi: 10.1029/2007JB005302 (2008); and M. D. Jackson, M. Y. Gulamali, E. Leinov, J. H. Saunders, and J. Vinogradov, Spontaneous potentials in hydrocarbon reservoirs during waterflooding: Application to water-front monitoring: SPE Journal, 17 (1), 53-69 (2012).

However, spontaneous potentials are not merely DC, and are measured as transient electric and/or magnetic fields. A. H. Thompson, and G. A. Gist, Geophysical applications of electrokinetic conversion: The Leading Edge, 12, 1170-1173; S. Pride, Governing Equations for the coupled electromagnetic and acoustics of porous media: Physical Review B, 50 (21), 15678-15696 (1994); P. W. J. Glover, J. Ruel, E. Tardiff, and E. Walker, Frequency-dependent streaming potentials of porous media—Part 1: Experimental approaches and apparatus design: International Journal of Geophysics, 846204, doi: 11.115/2012/846204 (2012). Accordingly, in one embodiment of the invention, the transient electric and/or magnetic fields of the SP are transformed to the frequency domain as processed SP data.

The measured transient electric and/or magnetic fields are the superposition of electromagnetic fields from SP, cultural noise, and telluric currents. Telluric currents are time-varying electromagnetic fields originating from natural sources, such as lighting and geomagnetic pulsations. Telluric currents vary with time of day, latitude, space weather, and atmospheric weather. Telluric currents are often the limiting factor in attempts to produce SP and induced polarization (IP) responses at low electromagnetic signal levels in surface-based SP and IP surveys. In at least some embodiments, electric and/or magnetic fields are measured with sensors located at a remote reference position that is sufficiently removed from the reservoir to not measure SPs. These remote reference sensors may be integrated as part of the same fiber optic sensor system used for measuring the electromagnetic fields of the SPs. A method of telluric cancellation is undertaken via the calculation of an inferred telluric current for each sensor measuring the electromagnetic fields of the SPs.

Modeling of the SPs requires frequency-dependent solutions to Maxwell's equations:

∇×E=−iωμH, (6)

∇×H=σE+L₁₁∇P+L₁₂∇T+L₁₃∇C, (7)

from which the inhomogeneous Helmholtz equation can be derived:

∇×∇×E+iωμσE=−iωμ[L₁₁∇P+L₁₂∇T+L₁₃∇C], (8)

and solved using any of the differential or integral equation methods while preserving the coupled continuity condition (5).

The purpose of inverting SP data for reservoir monitoring is to recover the water saturation model, from which the oil-water contact of the waterflood can be recovered. The oil-water contact is not an abrupt interface between oil and water, but rather is a zonal boundary where the oil saturation decreases from its in situ value to its residual value. To enable inversion, we express the formation conductivity σ as an analytical function of the water saturation S_{w} such that the sensitivities can be evaluated with the chain rule:

$$\frac{\partial E}{\partial {S}_{w}} = \frac{\partial E}{\partial σ} \times \frac{\partial σ}{\partial {S}_{w}} , \qquad ( 9 )$$

where the sensitivities ∂E/∂σ can be evaluated with adjoint operators, and ∂σ/∂S_{w} has a known analytical form. See e.g., P. R. McGillivray, D. W. Oldenburg, R. G. Ellis, and T. M. Habashy, Calculation of sensitivities for the frequency-domain electromagnetic problem: Geophysical Journal International, 116 (1), 1-4 (1994).

For example, we can choose the empirically-derived Archie's Law:

σ=α⁻¹σ_{w}φ^{m}Sⁿ_{w}, (10)

where φ is the porosity, α is the tortuosity factor, m is the cementation factor, n is the saturation factor, and σ_{w} is the water conductivity which may be a function of salinity and temperature. See G. E. Archie, The electrical resistivity log as an aid in determining some reservoir characteristics: Petroleum Transactions of the AIME, 146 (1), 54-62 (1942). Equation (9) is not restricted to Archie's Law, as any analytic function relating the conductivity and water saturation can be used.

The inversion of the SP data for the water saturation model is based on minimization of the Tikhonov parametric functional:

P^{α}(S_{w})=∥W_{d}d−W_{d}A(S_{w}) ∥_{D}²+α∥WₘS_{w}−WₘS_{w,apr}∥_{M}²→min, (11)

where d is the N_{d} length vector of observed data, S_{w} is the Nₘ length vector of the water saturation model, S_{w,apr} is the Nₘ length vector of the a priori water saturation model constructed from a priori geological, geophysical, and petrophysical information, W_{d} and Wₘ are data and model weighting matrices, respectively, and α is the regularization parameter which balances (or biases) the misfit and stabilizing functionals. The minimization of the parametric function (11) can be readily accomplished with any of the gradient based optimization methods. See e.g., M. S. Zhdanov, Geophysical inverse theory and regularization problems: Elsevier, Amsterdam (2002). It is noted that the inverse problem (11) is highly constrained with the inclusion of other a priori information from seismic, well, and production data.

In the processing steps of method 200, the minimization of the parametric functional (11) is subjected to the ancillary constraints that the total change in mass of water in the updated water saturation model is conserved:

m_{w}=∫_{V}ΔS_{w}(r)φ(r)ρ_{w}(r)d³r, (12)

where m_{w} is the total mass of water injected (known from production data), ρ_{w} is the water density (which may vary with salinity and temperature), and that the water saturation in the model can only increase:

ΔS_{w}(r)=S_{w}(r)−S_{w}(r)>0, (13)

and where the water saturation is bound:

0≦S_{w}(r)≦1−Sᵣ(r), (14)

where Sᵣ is the residual oil saturation. Ancillary constraints (12), (13), and (14) are novel to the disclosed technique and to time-lapse EM inversion for reservoir monitoring generally.

The recovered water saturation model can then be recycled to the multiphase flow simulator for updated pressure, temperature, and chemical transport. The process can be iterated for history-matching production data and evaluating injection and/or production scenarios for the interventionless management of well infrastructure such as multi-zone intelligent completions.

In another embodiment of the method, the SP data may be jointly inverted with other geophysical and/or production data. In one embodiment of the invention, the sensors may be electric and/or magnetic field sensors that are deployed on optical fibers. The system may have very small number of electrical and/or magnetic parts and may be composed of small modifications on the optical fiber that make the fiber sensitive to EM fields. A multitude of sensors can be placed in an array type of arrangement at axially separated positions along the well. The signals from different sensors can be multiplexed downhole, and demultiplexed and individually received at the surface. The measurement orientation can be in any arbitrary direction and three independent measurements at each spatial location can be made. A more detailed explanation of sensor systems that perform such measurements can be found in U.S. application Ser. No. 13/736,324 and U.S. application Ser. No. 13/736,487.

In accordance with at least some embodiments, the disclosed systems and methods include various features such as: permanent measurement of multi-frequency SP data; telluric cancellation of SP data for improved signal-to-noise; EM modeling of SP phenomena; constrained nonlinear inversion or imaging of SP data, including joint with other relevant data; generating water saturation models derived from SP data; integration with static and/or dynamic reservoir simulations for history matching and/or evaluating production and/or injection scenarios; and integration with well infrastructure such as multi-zone intelligent completions for optimizing injection and/or production. Related operations includes waterflood monitoring; enhanced oil recovery (EOR); enhanced gas recovery, CO2 monitoring, verification, and accounting (MVA); geothermal reservoirs; and hydrogeological monitoring for groundwater and/or contaminant mobility.

Numerous other variations and modifications will become apparent to those skilled in the art once the above disclosure is fully appreciated. It is intended that the following claims be interpreted to embrace all such variations and modifications where applicable.

What is claimed is:

1. A spontaneous potential (SP) monitoring system, comprising:
a plurality of EM field sensors positioned in a downhole environment; and
a processing unit in communication with the plurality of EM field sensors, wherein the processing unit determines SP data for the downhole environment using a multi-frequency SP model and EM field measurements collected by the plurality of EM field sensors,
wherein the processing unit performs an inversion process based at least in part on the SP data to obtain a model of subsurface fluid.

2. The system of claim 1, wherein the plurality of EM field sensors are permanently deployed in the downhole environment.

3. The system of claim 1, wherein the processor determines the SP data by applying telluric current cancellation to at least some of the EM field measurements.

4. The system of claim 1, wherein the multi-frequency SP model solves an inhomogeneous Helmholtz equation:
∇×∇×E+iωμσE=−iωμ[L₁₁∇P+L₁₂∇T+L₁₃∇C],
where E is an electric field; i is \sqrt{−1}; ω is an angular frequency; μ is a permeability value; σ is a conductivity value, Lᵢⱼ are coupling coefficients, ∇P is a pressure gradient, ∇T is a temperature gradient, and ∇C is a salinity gradient.

5. The system of claim 1, wherein the processor inverts the SP data to determine water saturation using minimization of a parametric function.

6. The system of claim 5, wherein the processor constrains the parametric function using a mass conservation constraint.

7. The system of claim 5, wherein the determined water saturation is bound by a constraint:
ΔS_{w}(r)=S_{w}(r)−S_{w}(r)>0,
where S_{w}(r) is a water saturation value at a point r in 3-dimensional space.

8. The system of claim 5, wherein the determined water saturation is bound by a constraint:
0≦S_{w}(r)≦1−Sᵣ(r),
where S_{w}(r) is a water saturation value at a point r in 3-dimensional space.

9. The system of claim 5, wherein the processor inputs the determined water saturation to a multiphase flow simulator to update pressure, temperature, and chemical transport values.

10. The system of claims 5, wherein the processor inputs the determined water saturation to a multiphase flow simulator to update injection or production rates.

11. The system of claim 2, wherein the plurality of EM field sensors are part of a fiber optic sensor array.

12. The system of claim 2, wherein the EM field sensors are part of an interventionless monitoring array to monitor at least one of waterflooding, steam injection, gas injection, CO₂ injection, and groundwater.

13. A spontaneous potential (SP) monitoring method, comprising:
receiving ambient EM field measurements from a plurality of EM field sensors at different positions in a downhole environment;
determining SP data for the downhole environment using a multi-frequency SP model and the received EM field measurements; and
performing an inversion process based at least in part on the SP data to obtain a model of subsurface fluid.

14. The method of claim 13, wherein determining the SP data comprises applying telluric current cancellation to at least some of the received EM field measurements.

15. The method of claim 13, wherein the inversion process determines water saturation using at least some of the SP data and minimization of a parametric function.

16. The method of claim 15, wherein the inversion process applies a mass conservation constraint to the parametric function.

17. The method of claim 15, wherein the determined water saturation is bound by a constraint that water saturation can only increase.

18. The method of claim 15, wherein the determined water saturation is bound by a constraint that water saturation is greater than or equal to zero and is less than or equal to one.

19. The method of claim 15, further comprising inputting the determined water saturation to a multiphase flow simulator to update pressure values, temperature values, salinity values, injection rates, or production rates.

20. The method of claim 13, further comprising positioning the plurality of EM field sensors in the downhole environment as part of a fiber optic sensor array.
